(19) United States
(12) Patent Application Publication
(10) Pub. No.: US 2007/0261003 A1
(43) Pub. Date: Nov. 8, 2007

(54) METHOD AND DEVICE FOR PROVIDING A SELECTION MENU ALLOCATED TO A DISPLAYED SYMBOL

(75) Inventor: Christian Reissmueller, Sulzberg (DE)

Correspondence Address: DARBY & DARBY P.C., P.O. BOX 770, Church Street Station, New York, NY, 10008-0770, US

(73) Assignee: COMBOTS PRODUCT GMBH, Karlsruhe (DE)

(21) Appl. No.: 11/745,711

(22) Filed: May 8, 2007

(30) Foreign Application Priority Data
May 8, 2006 (DE) 10 2006 021 400.5

(51) Int. Cl. G06T 15/70

(52) U.S. Cl. 715/810; 345/473

(57) ABSTRACT

A method and device for providing a selection menu allocated to a displayed symbol on a graphic display unit is provided. A user can perform a predefined action with an input device, and when the predefined action is detected in a spatial relationship to the displayed symbol, a selection menu enclosing the displayed symbol is displayed. The selection menu has a number of menu items which, when one of the menu items is selected, a function of the user program corresponding to the selected menu item can be executed. The selection menu is functionally and graphically allocated to the displayed symbol.

This application claims priority to German Patent Application No. DE 10 2006 021 400.5, filed May 8, 2006, the contents of which is hereby incorporated by reference as if set forth in its entirety.

The invention relates to a method and a device for providing a selection menu allocated to a displayed symbol on a graphic display unit.

### BACKGROUND

Terminals are often operated with operating systems which have graphical user interfaces. On such traditional graphical user interfaces, functions of a program operated in the terminal can be activated by choosing selection elements in selection menus. One form of such selection menus are, for example, known from a standard Windows application as pull-down menus which, when called by a mouse click on a corresponding symbol or generic term, display a list with the various selection elements, preferably displayed by text expressions. However, it can be confusing after calling the pull-down menu, in particular if symbols or generic terms to which such a selection menu is allocated are distributed over the display interface, to match the selection menu to the associated symbol or generic term, since the pull-down menu can be displaced if a margin of the display interface is too close.

### SUMMARY

In an embodiment of the present invention, a method and device for providing a selection menu allocated to a displayed symbol on a graphic display unit are provided. A user can perform a predefined action with an input device, and when the predefined action is detected in a spatial relationship to the displayed symbol, a selection menu enclosing the displayed symbol is displayed. The selection menu has a number of menu items which, when one of the menu items is selected, a function of the user program corresponding to the selected menu item can be executed. The selection menu is functionally and graphically allocated to the displayed symbol.

### BRIEF DESCRIPTION OF THE DRAWINGS

Exemplary embodiments of the present invention are explained in more detail below with reference to the accompanying drawings, in which:

FIG. 1 illustrates a schematic view of a communication system with two terminals according to the present invention; and

FIG. 2-FIGS. 16a-d illustrate various representations of graphic displays of selection menus on a graphic user interface according to the present invention.

### DETAILED DESCRIPTION

One feature of an embodiment of the present invention provides a method and a device in which selection elements of a selection menu are clearly displayed for a corresponding symbol to which the selection menu is allocated.

According to a feature of an embodiment of the present invention, a method is provided for preparing a selection menu allocated to a displayed symbol on a graphic display unit which comprises a display interface, with the help of an input device that can be operated by a user. In the method, a predefined action is detected with the input device in a spatial relationship to the displayed symbol. Also, upon detection of the predefined action, display of a selection menu enclosing the symbol, which has several menu items selectable via the input device, with the result that a function of a user program can be performed by selecting one of the menu items.

In an embodiment according to the present invention, because the selection menu encloses the symbol to which the selection menu is allocated, a clear spatial allocation of the selection menu to the symbol is also possible if the symbol is close to the margin of the display interface.

The input device is preferably a computer mouse with which a mouse pointer on the display unit can be controlled. Predefined actions of the input device include, for example: a left mouse click on the computer mouse; a right mouse click on the computer mouse; a mouse movement with or without operating one of the buttons of the computer mouse, such as a to-and-fro movement in a horizontal and/or a vertical direction or a circular movement.

The selection menu display can be ring-shaped, and the displayed symbol remains visible inside the ring-shaped selection menu. The menu items can be displayed as segments of the ring-shaped selection menu.

The segments are preferably each provided with a selection element, and the corresponding selection element can be selected with the help of the input device so as to select the function of the user program.

According to one embodiment of the present invention, when the mouse pointer is positioned on one of the selection elements, the relevant selection element can be highlighted by displaying it enlarged, laterally displaced, or in a different color on the display interface.

Furthermore, when the mouse pointer is positioned on one of the selection elements, an information selection element relating to the display of the corresponding selection element can be displayed, and help information can be provided when the information selection element is activated.

To display the selection menu, the selection menu can spiral out around the symbol by turning and enlarging until it has reached a definitive size. Furthermore, the selection menu can be removed by activating a farther function which is not provided by one of the menu items, in that the selection menu spirals inwards by turning and shrinking until it has completely disappeared from the display interface.

According to a further feature of the present invention, a device for preparing a selection menu allocated to a displayed symbol is provided. The device includes a graphic display unit which has a display interface, an input device, and a control unit in order to detect a predefined action with the input device in a spatial relationship to the displayed symbol. Upon detection of the predefined action, the device can display a selection menu enclosing the symbol which has several menu items selectable through the input device, with the result that a function of a user program operable with the device can be performed by selecting one of the menu items.

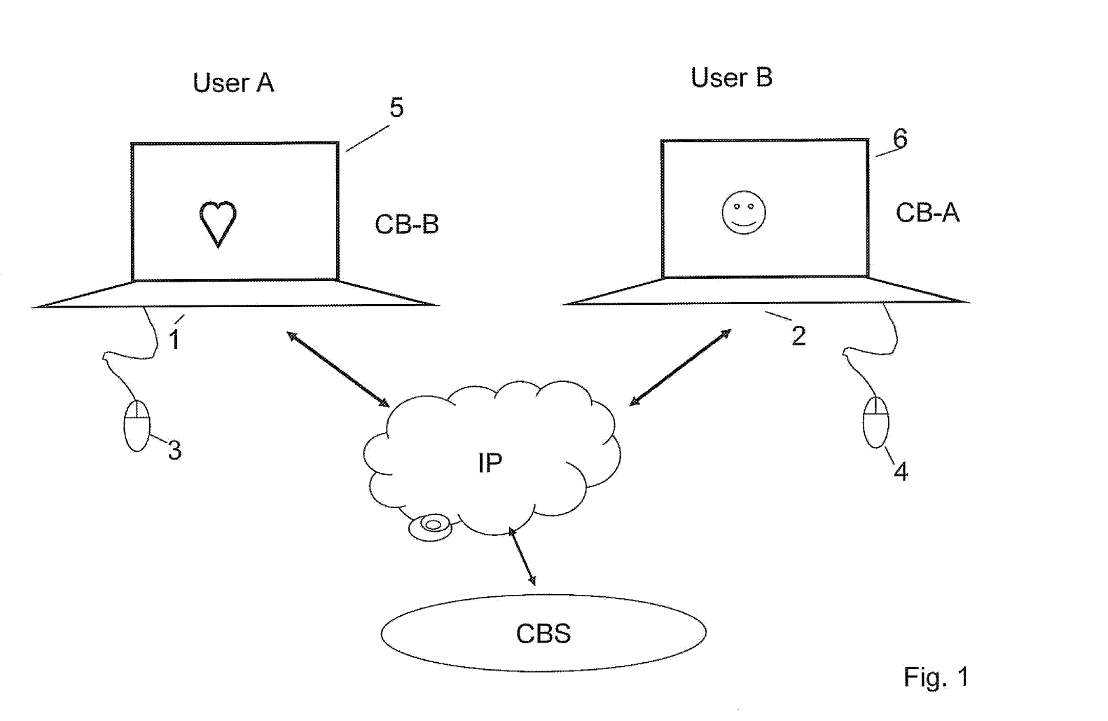

FIG. 1 shows a schematic view of a communication system in which two communication partners, user A and user B, can exchange data via a network, such as the Internet IP, in order to communicate with each other in various ways. It is noted that instead of using the Internet IP, other networks can also be used. The network nodes in the networks, and also the end-points at the users (end-nodes) form a decentralized organized network such as the communication system. The transmission of data for the communication can occur via the various nodes which have essentially equal access and, depending on data flow, perform the function of a send, destination or transmission node. The control device CBS essentially manages the decentralized organization of the communication system. In particular, the control device controls access to the communication system by verifying the user authorization or authentication. The communication system integrates or connects transmission methods from store-and-forward or peer-to-peer and all possible types of communication. Possible types of communication include voice telephony, e-mail, IM (instant messaging), exchange of data of all types and also the operation of file-sharing applications, whiteboard applications and others.

For communication, each user has at his disposal a corresponding terminal 1, 2 which are shown here as PCs (personal computers). Other terminals 1, 2, such as mobile telephones, PDAs (personal digital systems) and similar with which a user can construct a data connection to the network IP in order to communicate via it, come into consideration as terminals 1, 2. The terminals 1, 2 can be connected to suitable input and output devices ideally having a telephone headset, a mouse 3, 4, a keyboard and a screen 5, 6. The communication system has at its disposal the central control device CBS which controls, monitors, supports and/or organizes the communication between the terminals of users A and B. To this end, the central control device CBS has at its disposal suitable software which can control access to the system and control the basic mechanisms of the connection set-up between terminal 1 and terminal 2 of the corresponding users A and B.

One feature of the communication system of the present invention is the graphic communication element, herein referred to as ComBOTs™ below, which is shown schematically in FIG. 1 and provided with the reference items CB-B and CB-A. ComBOT™ and ComBOTs™ are a trademark of ComBOTS Product GmbH. A ComBOT™ is essentially an operable and animatable element (e.g., icon, symbol, figure, etc.) on the screen of terminal 1, 2 of the respective communication partner (e.g., user A) which represents the contact to the other communication partner (user B) and via which directly a communication can be carried out. For example, on the screen of terminal 1 of user A there is a ComBOT™ (CB-B) which represents the other user B. Conversely, there is a ComBOT™ (CB-A) on the screen of terminal 2 of user B. The look and appearance of the ComBOT™ can be determined by each user, preferably the user who is represented by the respective ComBOT™. In the example shown here, user A is represented by a smiley and user B by a heart.

In terminals 1, 2, application software, such as client software, is run and connects to the central control unit CDB in particular to a server installed there. The client software carries out an authentication of the respective user A, B in the communication system. The user also performs certain functions via the ComBOTs™ and specifies parameters for the user that can preferably be stored in user profiles inside the central control device. Furthermore, signalling data are exchanged with the help of the client software which runs on the respective terminal 1, 2. This allows the central control device to control or at least prompt the construction of various transmission paths within the network for the transmission of the useful data required for communication.

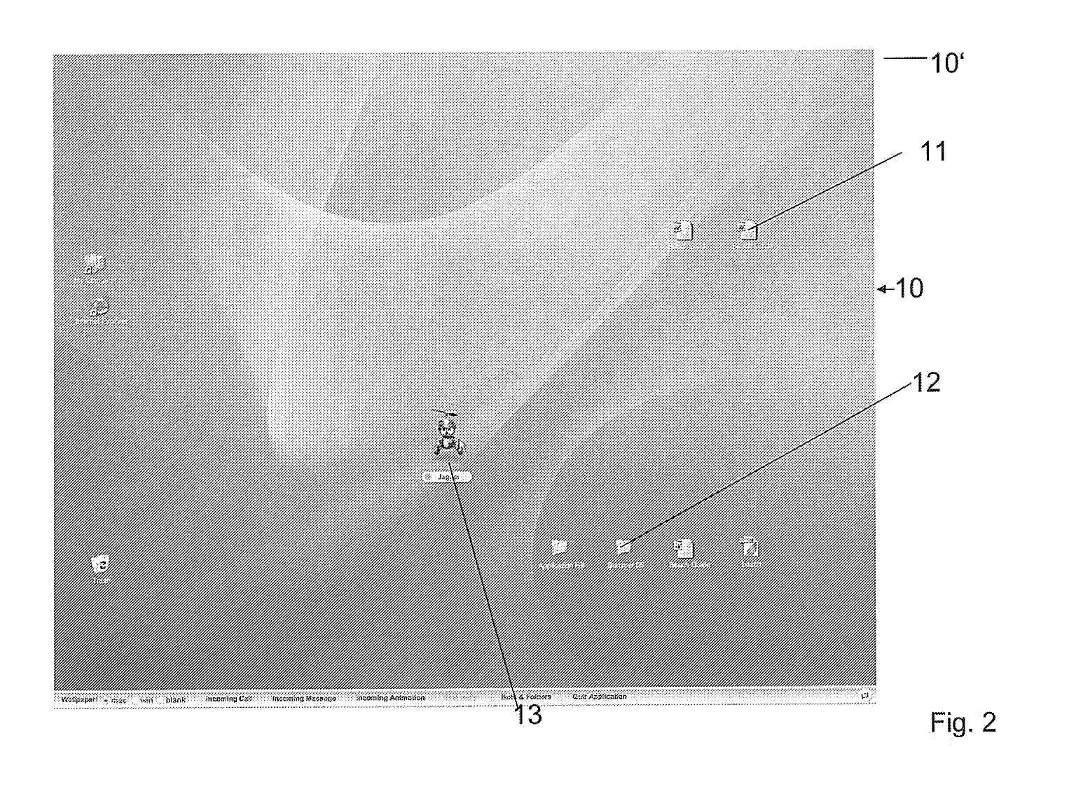

The running of the client software via an interaction with the ComBOT™ CB-B, CB-A, on the screen or display unit of the respective terminal is described in more detail below. To this end, the user's possibilities for interaction with a ComBOT™ displayed on his screen, which represents a further user as communication partner, are shown in FIGS. 2-16.

FIG. 2 shows a display interface 10′ in the form of a user interface or desktop of a conventional operating system in which symbols for files 11 and folders 12 are arranged on a background surface 10, i.e., a surface of the screen display which is not shown in a window. By double-clicking on the respective symbol 11, a user can open the file, executing it if an executable program file is involved or with a linked application if the file is a content file, such as a text file. By double-clicking on a symbol 12 which represents a folder, a folder window is opened in which symbols for several files located therein, or further folders, are displayed which the corresponding user can execute or process in the manner described above.

Also located on the background surface 10 or the display interface 10′ shown in FIG. 2 is a ComBOT™ 13 which, in the shown embodiment example, is a figure with a propeller hat, called “propeller man” below. The propeller man is a ComBOT™ 13 for a second user, e.g., user B, connected to terminal 1, 2 of the user, e.g., A, with whom there is a communication connection. Displayed below the propeller man is a label with the name “Jagger”, which can display the name of communication partner B represented by the propeller man. The propeller man including the label optionally to be provided is thus the ComBOT™ 13 which represents the communication partner B “Jagger”.

The propeller man is preferably animated and performs a circular movement according to a first animation sequence, with the result that it serves to catch the eye of the user A, B on the background image. The animation of the ComBOT™ 13 can essentially be selected preferably by the communication partner to whom it corresponds, depending on the situation, and a static ComBOT™ 13 can also be selected depending on the currently available computing and/or storage capacity.

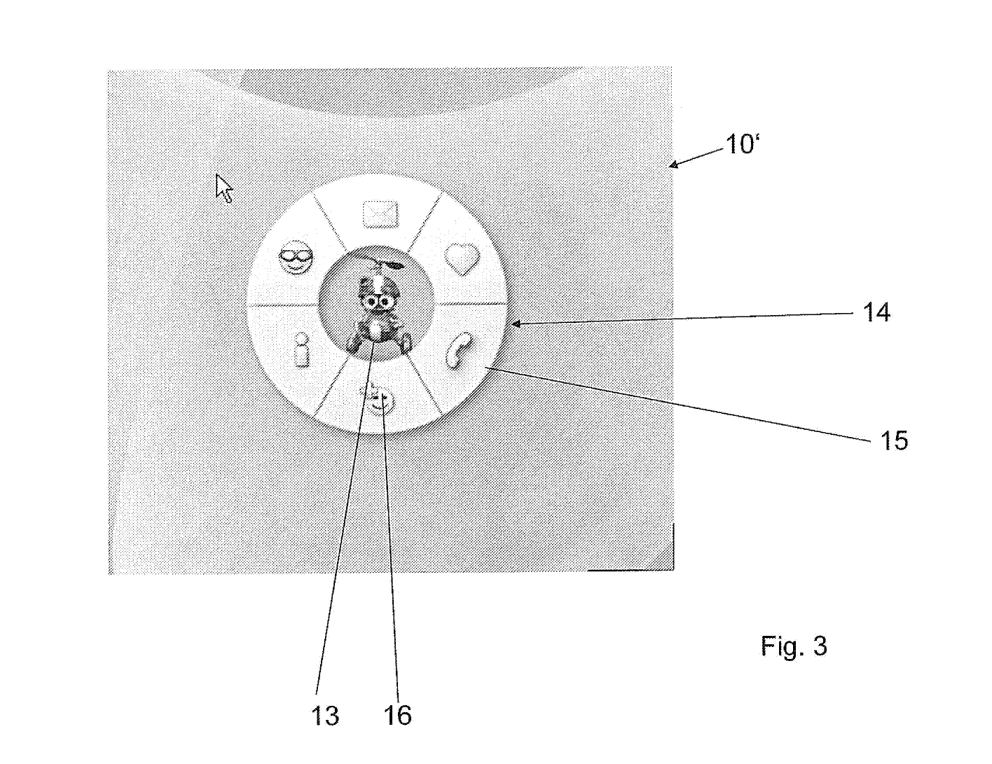

In an embodiment of the present invention, functions that are executed by the client program which is allocated to ComBOT™ 13 can be activated in various ways. To gain access to these functions, a particular selection menu 14 or user menu, here called ComBOT™ menu, is opened by a suitable activation such as a left or right mouse click, controlled by the corresponding computer mouse 3, 4, on the ComBOT™ 13 (or on a symbol allocated to same), which allows a selection of various functions of the client program. An example of such a ComBOT™ menu 14 is shown in FIG. 3. The ComBOT™ menu 14 can also be opened by a mouse movement such as a mouseover which is executed via the relevant ComBOT™ 13 or in another spatial relationship to the position of ComBOT™ 13 on the display interface of the screen. Thus, for example, with the help of a circular movement when there are several ComBOTs™ located on the background image or display interface 10′ preferably around the ComBOT™ 13 to be selected, a ComBOT™ 13 can be selected and the selection menu or ComBOT™ menu 14 activated for a subsequent selection of a desired function, with the result that the ComBOT™ menu 14 is displayed on the background surface 10 or display interface 10′ of the screen.

The selection menu or ComBOT™ menu 14 is preferably displayed enclosing the ComBOT™ 13 and has segments 15 which have selection elements 16. The ComBOT™ menu 14 is thus not only functional for the respective ComBOT™ 13, but also graphically directly allocated thereto. The selection elements 16 can be activated by clicking or by other actions. The ComBOT™ menu 14 enclosing ComBOT™ 13 can be ring-shaped, elliptical or also otherwise enclosing the ComBOT™ 13, with the result that the ComBOT™ 13 remains visible in the middle of the ComBOT™ menu 14 and the individual segments 15 with the selection elements 16 arranged therein in a group around the ComBOT™ 13. The ring-shaped ComBOT™ menu 14 has the advantage that a direct allocation of the menu to the corresponding ComBOT™ 13 is possible, with the result that, in particular when there is a larger number of different ComBOTs™ 13 which represent different communication partners, the ComBOT™ menu 14 clearly represents one of the communication partners. Namely, the communication partner who corresponds to the ComBOT™ 13 displayed inside the ring-shaped ComBOT™ menu 14, in this case the propeller man, is clearly represented. In this manner, it is possible to have a clear allocation of the ComBOT™ menu 14 to the corresponding ComBOT™ 13 when several ComBOT™ menus 14 are open.

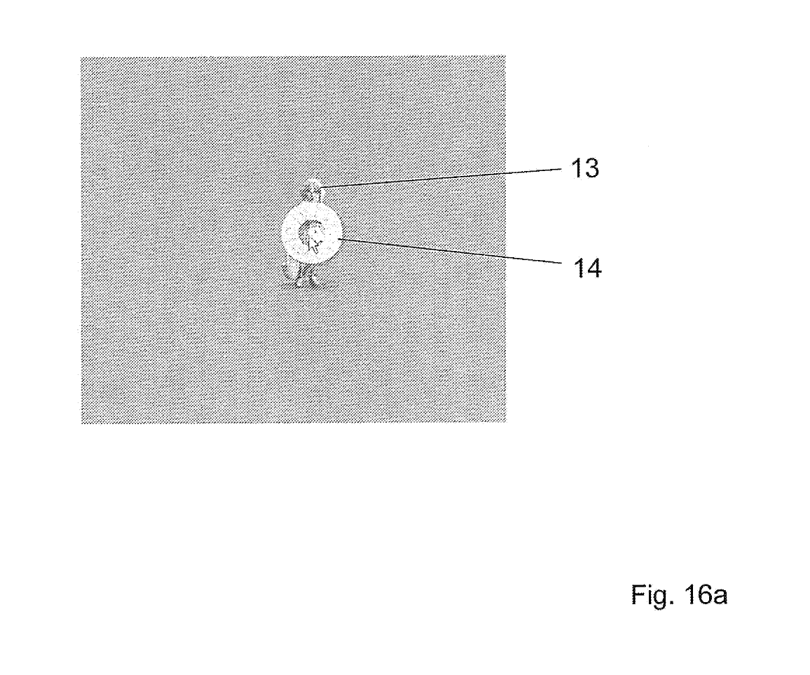

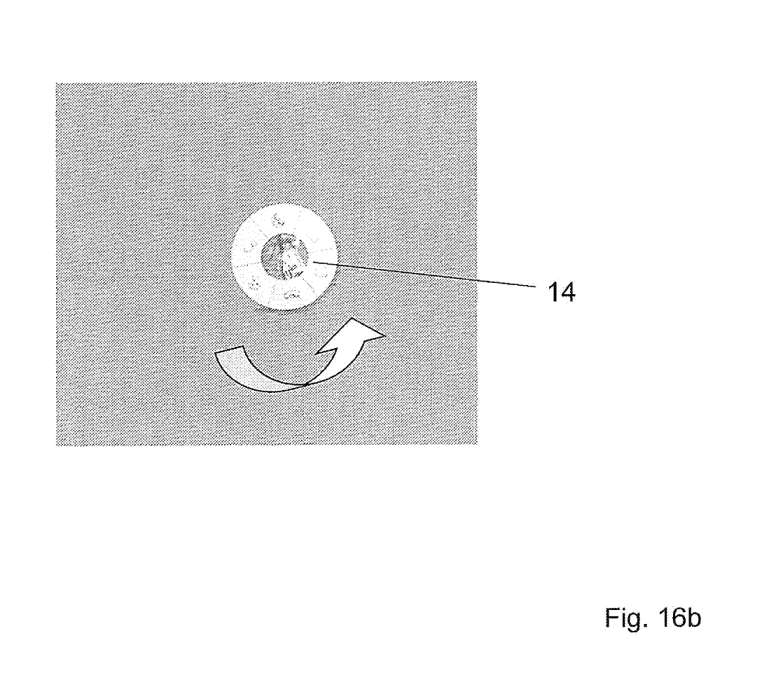

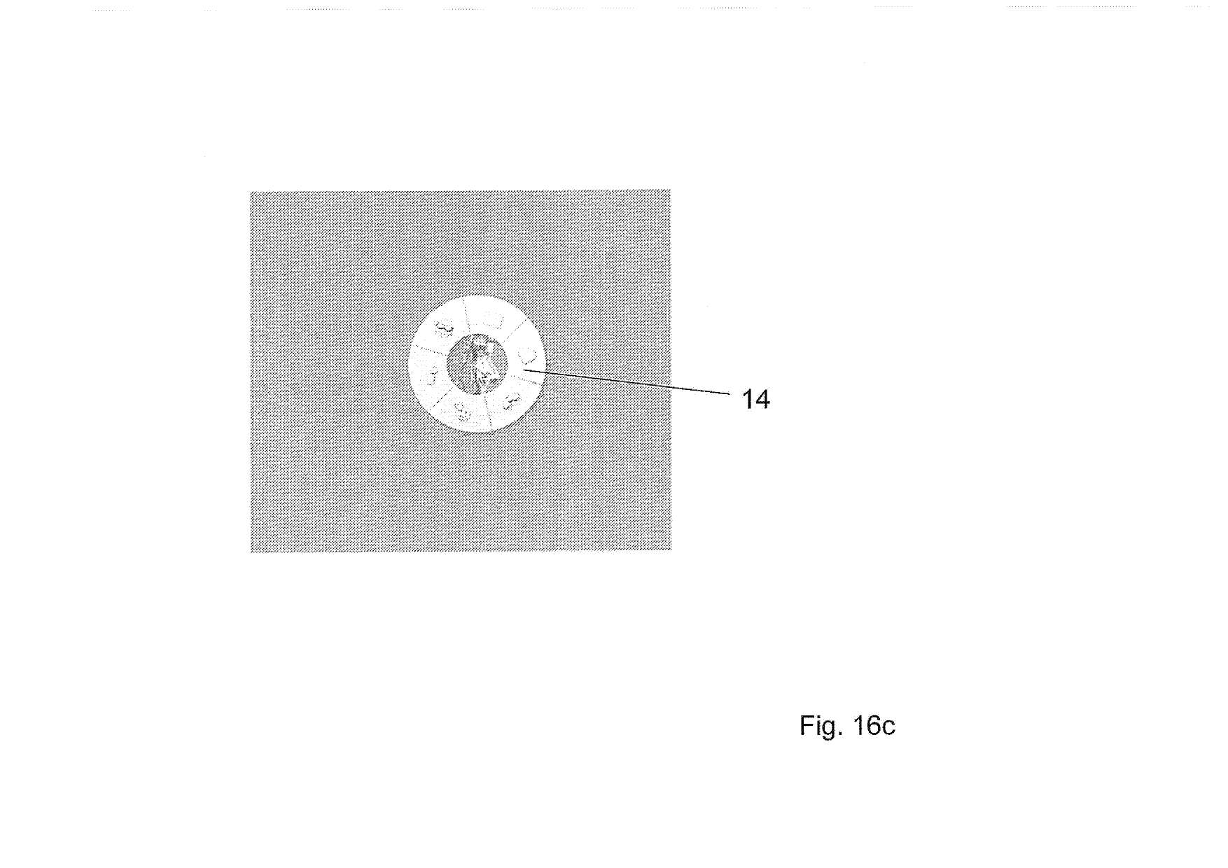

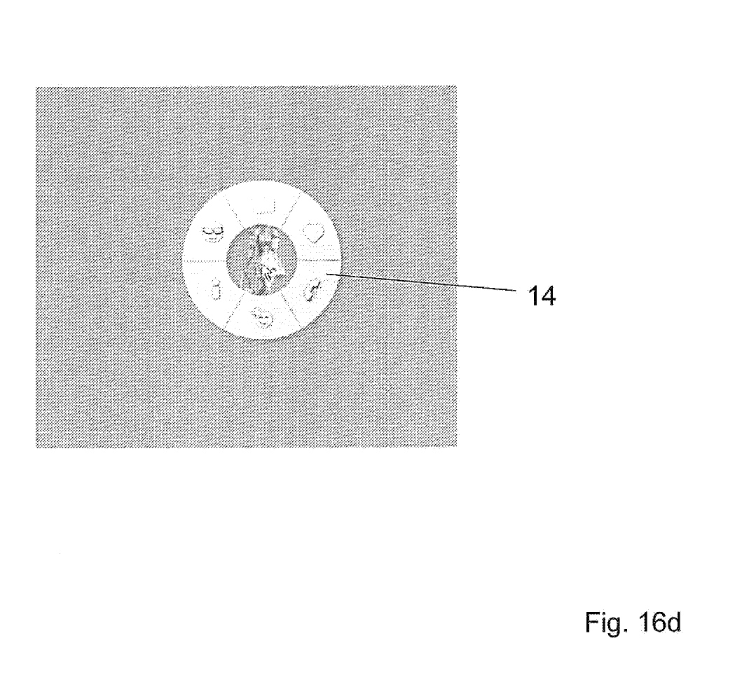

The ComBOT™ menu 14 can appear by activating the ComBOT™ 13 in a manner as described above (e.g., clicking, mouse movement, keyboard shortcut, etc.) such that the ComBOT™ spirals outwards. The ring-shaped ComBOT™ menu 14 enlarges starting from the ComBOT™ 13 until it has reached its definitive size, and turns while doing so, with the result that the arrangement of the individual segments 15 and the selection elements 16 contained therein correspond to a predefined arrangement. This feature is also illustrated in FIGS. 16a to 16b, which show, by way of example in individual images, the progress or the sequence of a ComBOT™ menu 14 opening spirally around a ComBOT™ 13.

The ComBOT™ menu 14 can be deactivated when another function is executed on the background surface of the terminal, or when the ComBOT™ menu 14 of a ComBOT™ 13 representing a further communication partner is activated. The ComBOT™ menu 14 can also be deactivated by clicking, for example, on an empty part of the background surface 10. When the ComBOT™ menu 14 is deactivated, the ComBOT™ menu 14 preferably disappears in a manner similar to that in which it appeared, namely by spiralling in again, such as by turning and simultaneously shrinking until it disappears at the location of the ComBOT™ 13. When the ComBOT™ menu 14 is activated, the ComBOT™ 13 can execute a second animation sequence as further eye catcher which differs from the first animation sequence when the ComBOT™ menu 14 is deactivated.

The segments 15 of the ComBOT™ menu 14 are preferably ring segments in the shown embodiment example which completely enclose the ComBOT™ 13. Depending on the number of functions provided for the client program, the ring segments 15 can be enlarged and reduced, and the ComBOT™ menu 14 can also comprise several rings with respective segments 15 which are arranged concentrically beside each other around the corresponding ComBOT™ 13. As a result of this formation and arrangement of the selection menu 14, the menu 14 can easily be expanded, e.g., by incorporating further segments into the existing ring or by adding one or more further rings with segments such as in the form of selection elements for sub-menu items and/or functions. In this manner, clarity can be preserved even when the menu 14 is expanded.

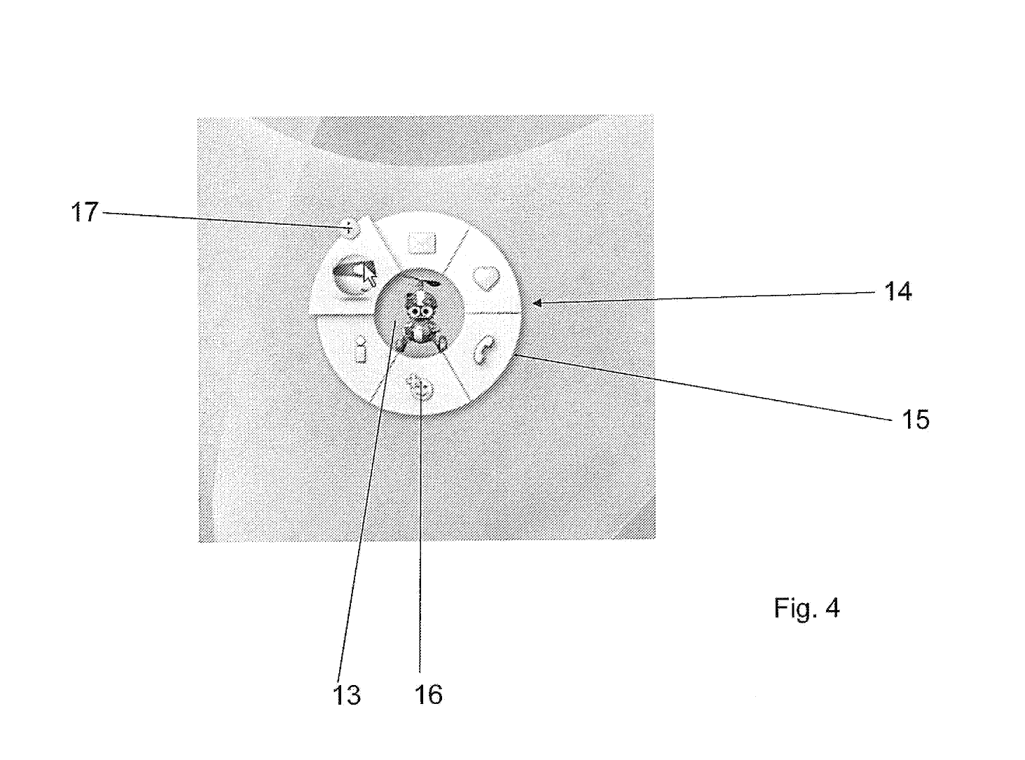

As shown in FIG. 4, as soon as the mouse pointer is moved over a segment 15 of the ring-shaped ComBOT™ menu 14, the respective segment 15 stands out. hi the example, it is displayed enlarged and/or can be arranged offset vis-à-vis the original position of the segment 15. In particular the activated segment 15 moves outwards, i.e., it moves from the idle position into an activation position. Furthermore, the colors of the selection element 16 displayed in the segment 15 can change, with the result that it is easily recognizable that a function allocated to the selection element 16 can be activated by clicking or other actions. The selection element 16 can be static or animated, in order to direct the attention of the user to the segment 15 of the ComBOT™ menu 14 that has been selected in this way. In particular, upon activation, the selected segment itself and/or the selection element or selection symbol connected to it (e.g., telephone receiver) can be animated in order to display the activation status. When one of the segments 15 of the ComBOT™ menu 14 is highlighted, the segment 15 can also be provided with an information selection element 17 which, in this example, is circular and is located on an outer edge of the respective segment and contains a symbol “i”, which represents help menus or information. If the mouse pointer now moves from the activated segment to the information selection element 17 according to a mouseover function or other action, either a textbox can immediately appear which contains help information, or a further menu with selectable functions can be activated, or a help film sequence can be displayed to explain the selection element 16 to which the information selection element 17 belongs.

Both the activation of a segment of the ComBOT™ menu 14 and the activation of the information selection element 17 can be “commented” with a changed animation of the ComBOT™ 13 displayed inside the ring-shaped ComBOT™ menu 14. In particular, upon activation of the information selection element 17, the animation of the ComBOT™ 13 can back up or supplement the explanation of the function of the segment 15 of the ComBOT™ menu 14 that is allocated to the information selection element 17.

In an embodiment according to the present invention, a selection element 16 of the ComBOT™ menu 14 makes available, for example, a telephone function which is displayed as a telephone receiver symbol in a corresponding segment 15 of the ComBOT™ menu 14. If the mouse pointer is moved to the telephone receiver symbol and then to the information symbol “i”, the animation of the ComBOT™ 13 inside the ring-shaped ComBOT™ menu 14 can change and the latter displays, for example, dialling a telephone and holding a receiver to his head, with the result that a user is shown the function of the segment 15 of the ComBOT™ menu 14 as an animation. Thus, foreign-language users can also be helped via the information selection element 17.

In particular, the ring-shaped selection menu or ComBOT™ menu 14 allows for a permanent allocation of the ComBOT™ menu 14 to the respective ComBOT™ 13. This provides the benefit that irrespective of the number of selection elements or menu items 16 to be provided, a clear allocation to the communication partner represented by the ComBOT™ 13 can take place.

If a segment 15 of the ComBOT™ menu 14 is connected to further subfunctions, these subfunctions can be displayed as a ComBOT™ submenu, which can extend in a ring-shape as an additional ComBOT™ menu 14 or as a ring segment around the already displayed ComBOT™ menu 14, and can have further segments which are each linked to the specific subfunctions.

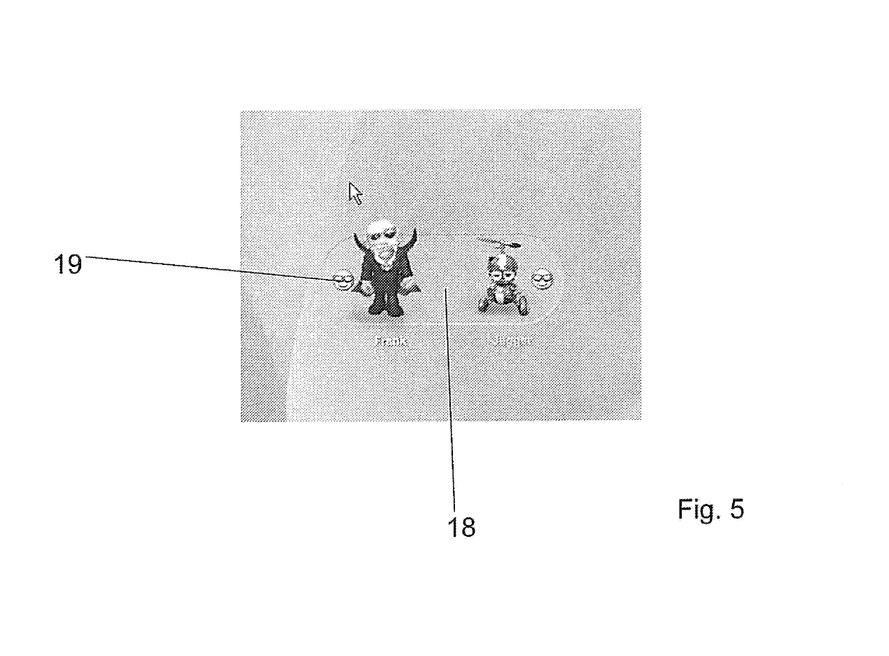

As displayed in FIG. 5, a so-called arena 18 opens in which both the ComBOT™ 13, which represents the user of the current terminal, in this case “Frank”, who is displayed as a ComBOT™ figure “Dracula”, and the ComBOT™ 13, which shows the communication partner “Jagger” (as propeller man) allocated to the activated ComBOT™ 13, are displayed. The two ComBOTs™ 13 are located inside a graphically delimited zone, called arena 18 below, which is displayed in a different color and/or by a suitable border around the two ComBOTs™ 13.

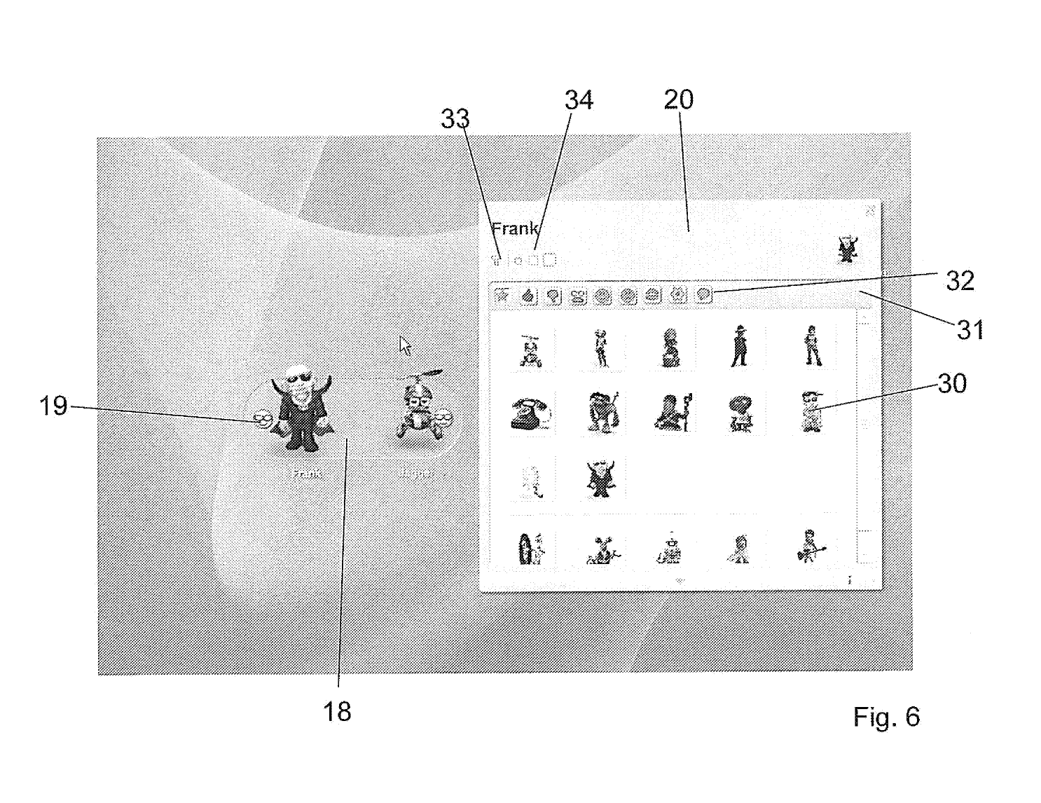

Beside each of “Frank”'s ComBOT™ 13 and “Jagger”'s ComBOT™ 13, a smiley symbol 19 is displayed with which, as is shown in FIG. 6, another selection menu in the form of a grid can be opened by clicking, the image of the ComBOT™ 13 allocated to the smiley being able to be changed in the arena 18. Depending on which ComBOT™ 13 smiley is activated, the image of the current user of the terminal or the image of the communication partner “Jagger” can be changed.

This grid-like selection menu 20 displays a number of different ComBOT™ image forms 30 which are predefined but can also partly be defined by the user. Furthermore, ComBOT™ image forms 30 can be displayed which may not be immediately available for selection, but can be obtained from a provider of such ComBOT™ image forms.

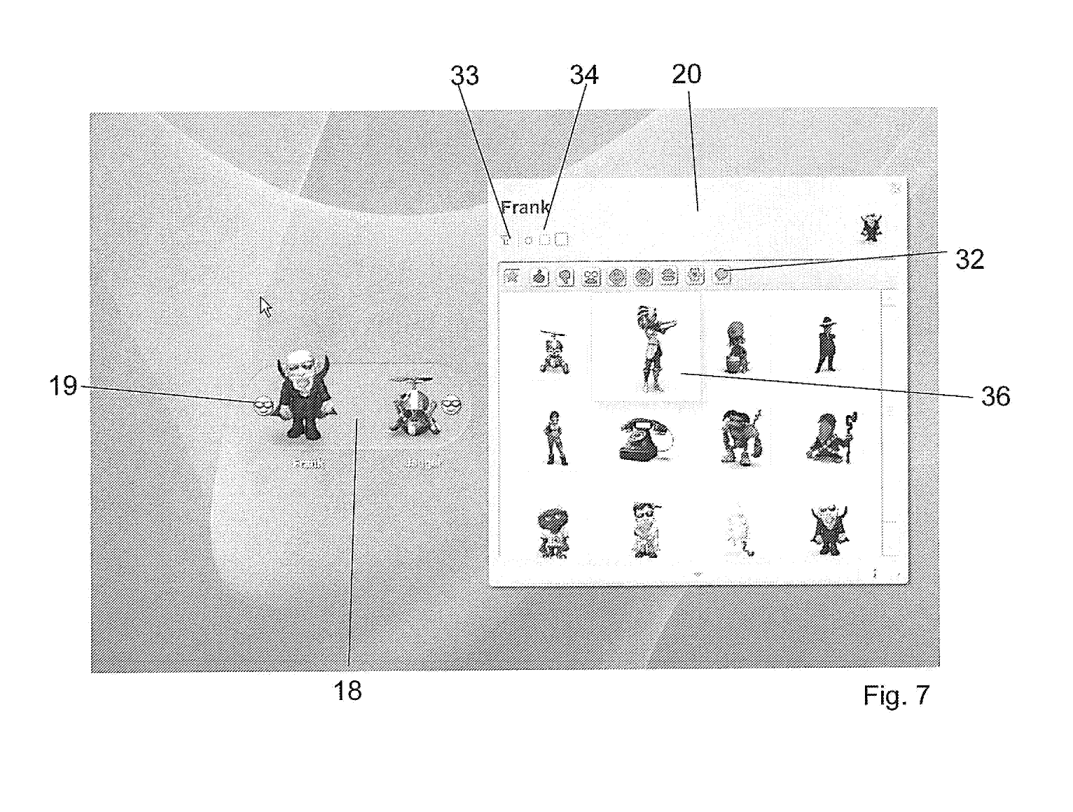

In a header area 31, the nature of the respective ComBOT™ image can firstly be selected via a suitable header element 32, and the respective ComBOT™ image form to be selected can then be selected by moving the mouse pointer over the ComBOT™ image forms displayed in a grid. Once the mouse pointer moves over the ComBOT™ image form, the latter is enlarged and highlighted (see FIG. 7, reference number 36), with the result that the user can review his choice before making his selection. It is furthermore provided that the ComBOT™ image 30 over which the mouse pointer is located is displayed with an animation.

A text-selection element 33 and one or more enlargement-adjustment elements 34 can also be provided. The text-selection element 33 serves to switch on or off the display of a text allocated to the ComBOT™ image, such as, for example, a name, a greeting or other information. The enlargement-adjustment elements 34 serve to adjust the size with which the ComBOT™ images 30 are displayed in the grid of the selection menu 20.

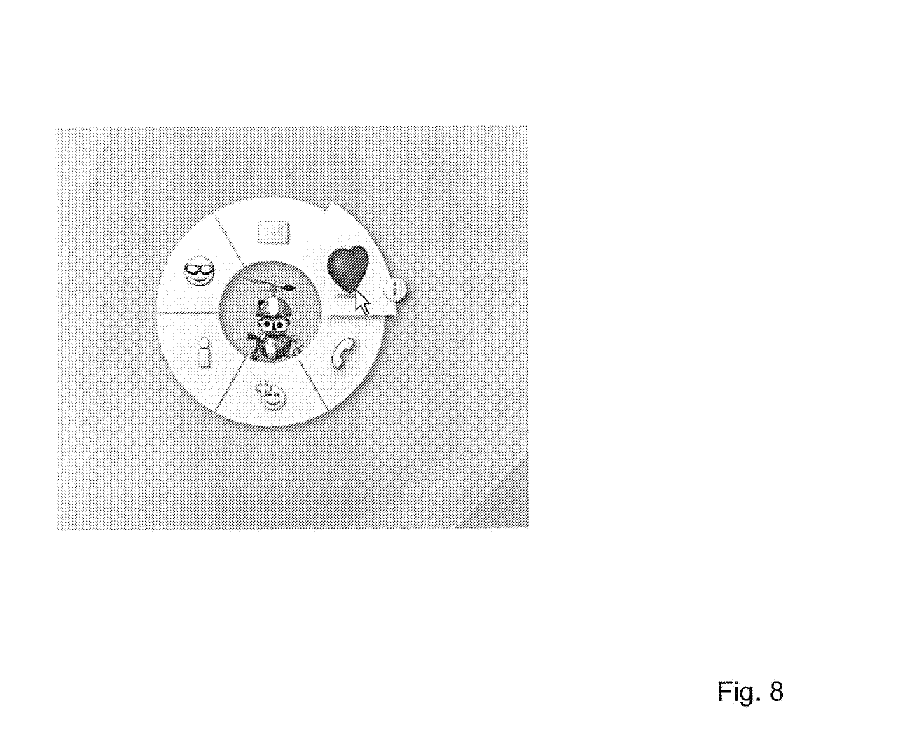

In an embodiment of the present invention, there is provided in the ring-shaped selection menu or ComBOT™ menu 14 a further segment 15 which, in the shown example, is provided with a heart symbol (see FIG. 8) via which the connected communication partner can be sent a specific animation in order to establish a non-verbal communication. The communication partner, that of the relevant ComBOT™ 13 to which the ComBOT™ menu 14 is allocated, receives corresponding animation data which result in a specific animation of the ComBOT™ 13 allocated to the current user being executed on the background surface 10 or display interface 10′ of the terminal of communication partner B. This means that user A's ComBOT™ 13 executes on the background surface of user B's terminal an animation which user A has selected in order to communicate non-verbally with user B.

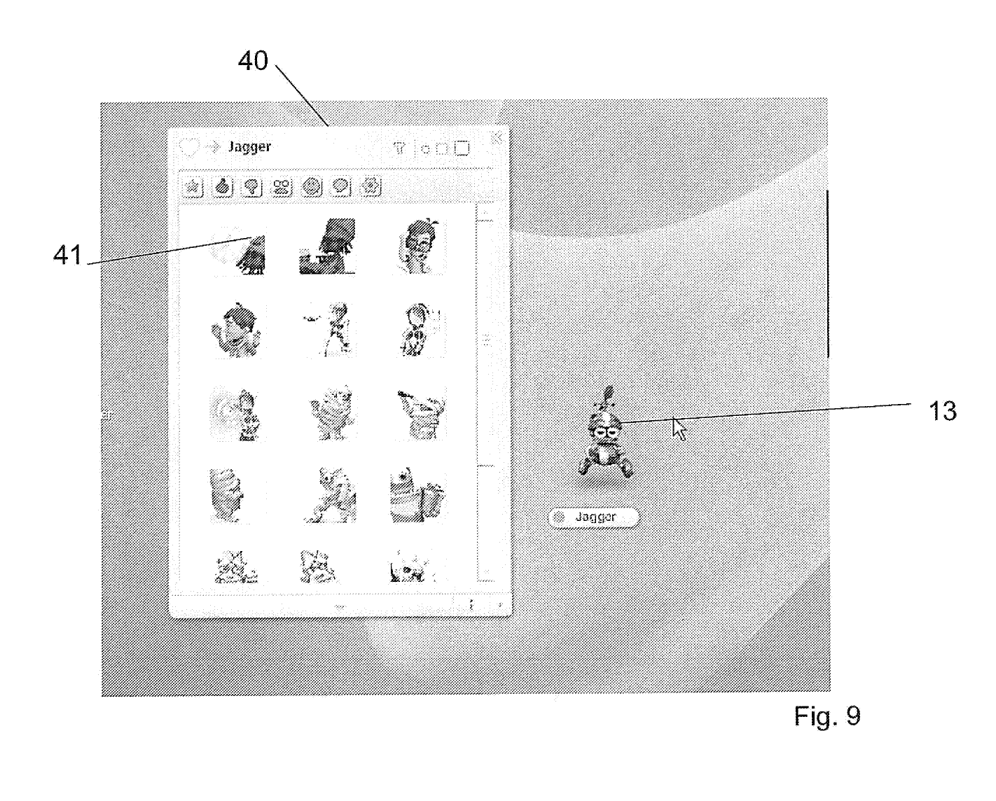

The animation can be selected via a so-called animation selection menu 40 which is shown by way of example in FIG. 9. The selection is carried out by displaying in one grid different animation symbols 41 which, when the mouse pointer moves over them in a mouseover function, are displayed enlarged and begin to execute the animation allocated to them. The animations can be divided into groups which can be selected through suitable header elements 42 in order to display animation symbols 41 for different emotions or information for the selection of the suitable animation. Possible animations are, for example, the handing over of a present, laughter, anger, etc., which are allocated to the ComBOT™ 13 which represents user A and which are sent to the selected communication partner B, with the result that the corresponding ComBOT™ 13 allocated to the current user selecting the animation executes the animation.

The structure of the animotion-selection menu 40 is substantially similar to that of the selection menu 20 for the ComBOT™ images, wherein the animation is executed once the mouse pointer moves over one of the ComBOT™ images shown there. The provided animations can be generally valid, with the result that they can be executed regardless of the ComBOT™ image used by the current user, i.e., with any ComBOT™ image, or can also be carried out with only a few specific or only one ComBOT™ image 30.

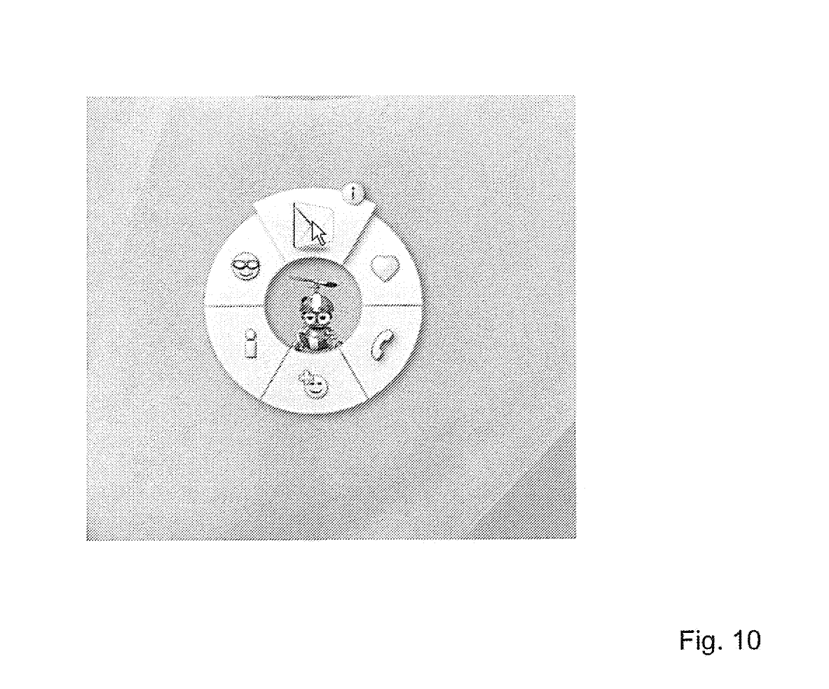

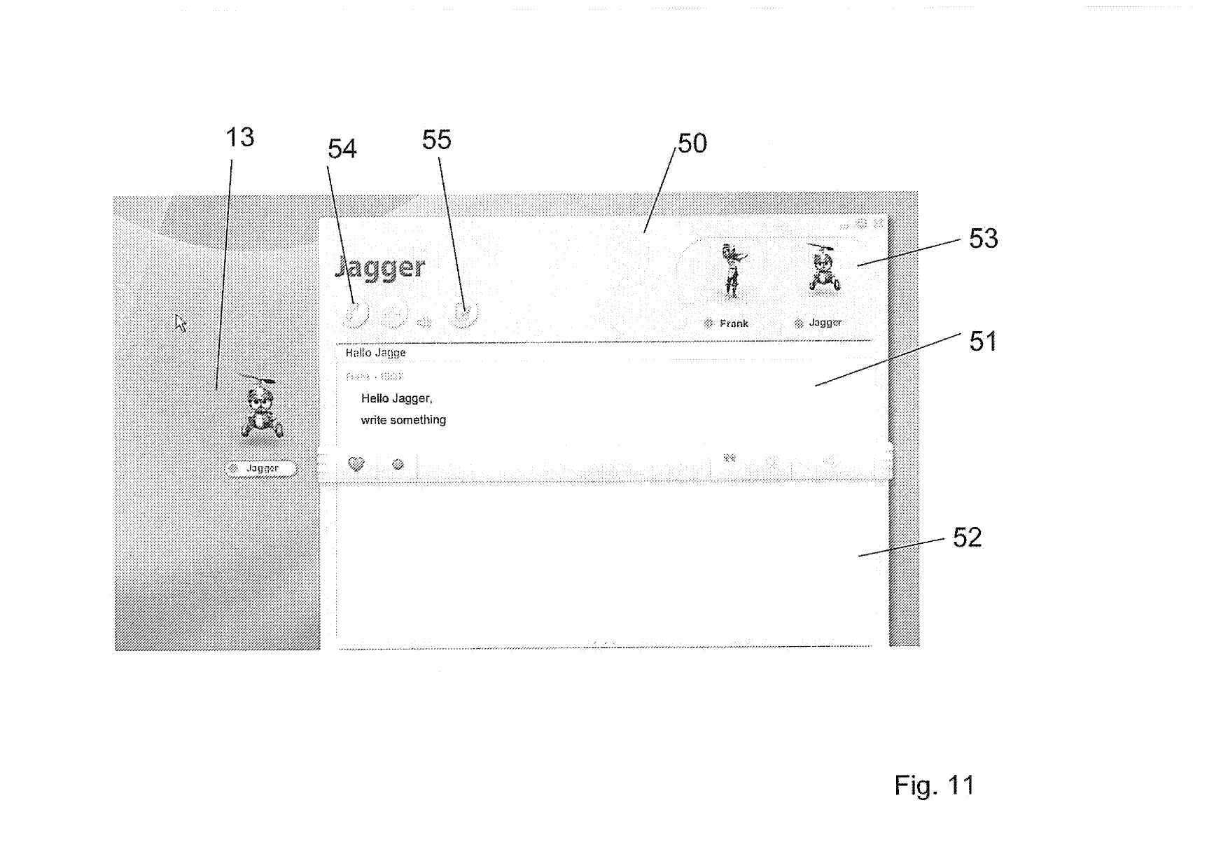

Upon selection of a segment 15 of the ComBOT™ menu 14 in which the selection element 16 is displayed as an envelope (see FIG. 10), a communication window 50 is opened with which the current user can communicate with the communication partner via, for example, an IM (Instant Messenger) connection. This is shown in FIG. 11. For this purpose, the communication window 50 is designed in two parts and shows in a first subwindow 51 the texts written by the current user and the communication partner. In a second subwindow 52, the current user can compose messages which he can send by pressing the “Enter” key, and which are then displayed in the first subwindow 51 of both the current user and the communication partner to whom the written text message is being transmitted.

The communication window 50 can furthermore have an area in which a history of the most recently conducted IM discussions is listed. The history is a listing of communication or conversation already conducted and includes all the events or sections of the previously conducted communication, i.e., exchange of messages, text, images, documents, etc. both in real time or virtual-real time and also time-shifted. The system of the present invention supports and integrates all types of communication, with the result that the customary distinctions between synchronous and asynchronous communication, such as e.g., Instant Messaging or e-mail, do not occur here. The users can communicate with each other at any time and by multimedia, without having to be concerned about the transmission method, online presence of the partner or similar.

Furthermore, both the ComBOT™ image of the current user and the ComBOT™ image of communication partner B can be displayed in one arena area 53 of the communication window. The current user A can select a suitable ComBOT™ image for every possible communication partner with whom the current user A is or can be connected, with the result that the current user A is displayed to different communication partners with different ComBOT™ images.

Furthermore, the communication window 50 can have a telephone selection element 54 to establish a telephone connection, and a file selection element to attach a flagged message or attach a file, so that further data, which can be sound, image or video data for example, can supplement the text message.

A further function which the client program of the present invention makes available is that files can be dragged onto the ComBOT™ 13 on the background surface 10 of the screen by drag-and-drop. The file symbol is selected and, with mouse button depressed, guided over the ComBOT™ 13 and the mouse button released there. The file allocated to the file symbol is then sent immediately to the communication partner allocated to the ComBOT™ 13.

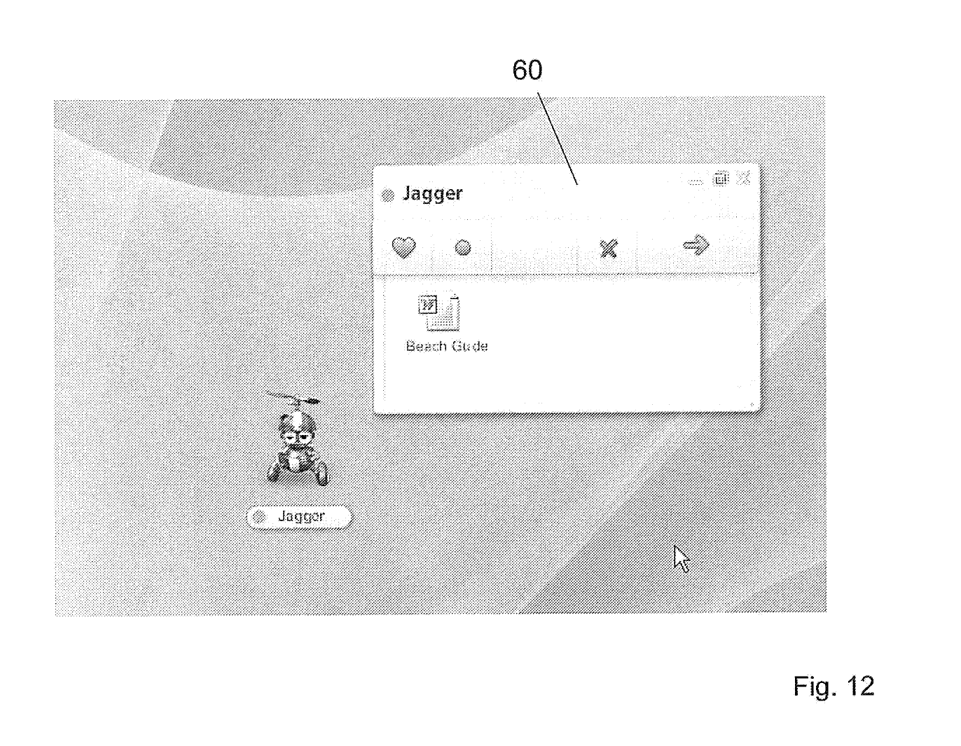

The result of “dropping” the file symbol onto the ComBOT™ 13 of the communication partner is that, as shown in FIG. 12, a second communication window 60 is automatically opened. However, the second communication window 60 is smaller but likewise allows a text input which can be sent to the communication partner allocated to the ComBOT™ 13 by pressing the Enter key. In this embodiment, the second communication window has no first subwindow to display the previously written texts. In particular, after inputting a text and then pressing the “Enter” key, the second communication window can automatically be closed and the file and the input text sent to the communication partner.

After the file symbol is dropped onto the ComBOT™ 13, the second communication window 60 is opened and a small presentation, e.g., a preview of an image or a video sequence, is already displayed in the second communication window, so that the current user can ensure that he has “dropped” onto the ComBOT™ 13 the correct file which is to be sent to the allocated communication partner.

Generally speaking, the display of communication windows, application windows or operating windows can be linked to the different functions which are called in the client program. In the client program, the size and the functions available therein of the communication window can be different, depending on the type of function called. This is advantageous because, when sending a file, often only a one-off very short text communication from the current user is needed to comment when required on the file. On the other hand, if the current user consciously chooses an IM connection, he usually has it in mind to carry out a lengthier communication with the allocated communication partner.

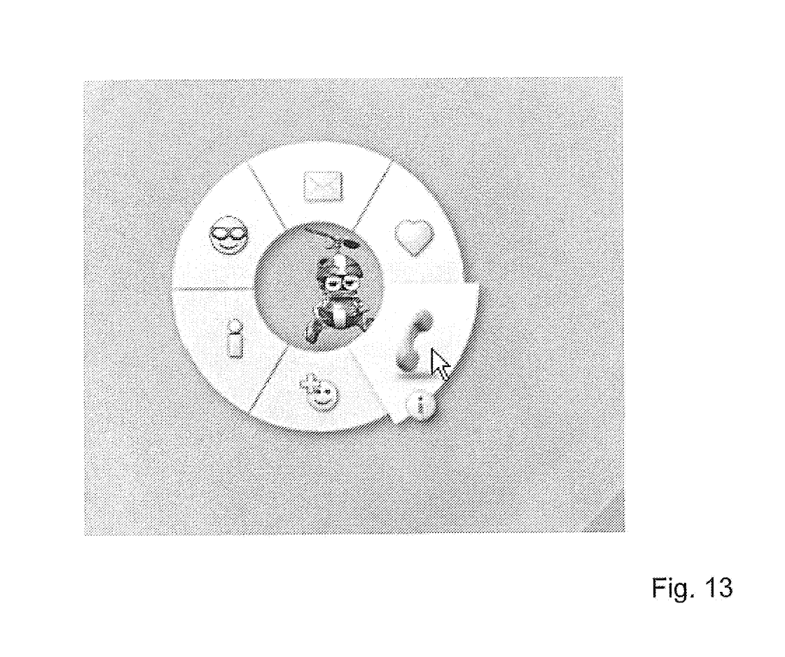

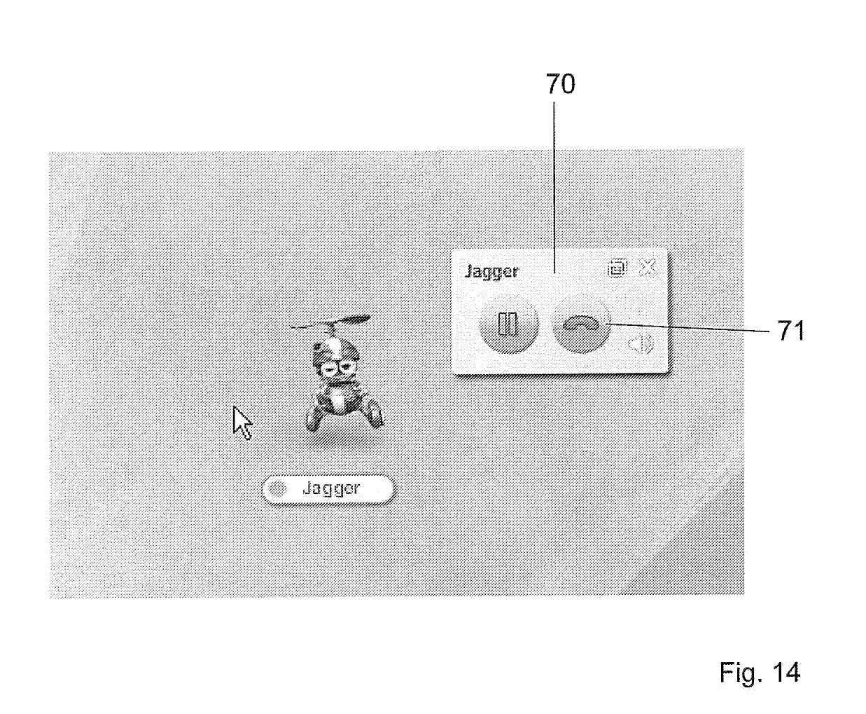

The display of a communication window, application window or operating window, subsumed under the term communication window, or window for short, can furthermore also be made dependent on what type of communication the current user selects. Thus for example if the corresponding segment 15 of the ComBOT™ menu 14 is selected to establish a telephone connection (see FIG. 13), a third communication window 70 (see FIG. 14) can simultaneously be opened which is merely provided with operating elements to change settings relating to the called program function. As the telephone connection represents the main communication level, no space for making entries is required here, with the result that a communication window provided merely with the operating elements 71 is sufficient. On the other hand, when establishing a communication connection, as described above, a large first communication window is displayed.

Furthermore, the size of the communication window and the functions that can be selected therein can be executed depending on the operating function with which the user selects or starts the application. The operating function can be specified, for example, with a mouse click, with a drag & drop, or with a mouse movement over a specific area of the display interface such as a mouseover. In this way, the user can determine the size and functionality of the communication window by choosing how the desired function of the client program is called. Thus the same function can be called in different ways, with the result that in addition to executing the corresponding function a communication window dependent on the type of call is displayed.

Alternatively or in addition, the size of the communication window and the functions that can be selected therein can be determined depending on whether a specific function of the client program is selected or started by the current user of the corresponding terminal or whether for example the communication partner connected to the current user starts a specific function of the client program at the current user via the communication connection. Thus a communication window with a specific size and with specific functions can be displayed when a call is made by the communication partner, the latter writes an e-mail and similar. The communication window opened in these cases can differ in size and functionality from those which are opened by actions of the user himself.

Furthermore, each call of a function of the client program via the ComBOT™ 13 can preferably lead to the display of a corresponding communication window, matched thereto, further specific subfunctions being selectably displayable by corresponding selection elements to execute the function. In particular, the communication windows can have subwindows for inputting and transmitting text messages by pressing a text message selection element.

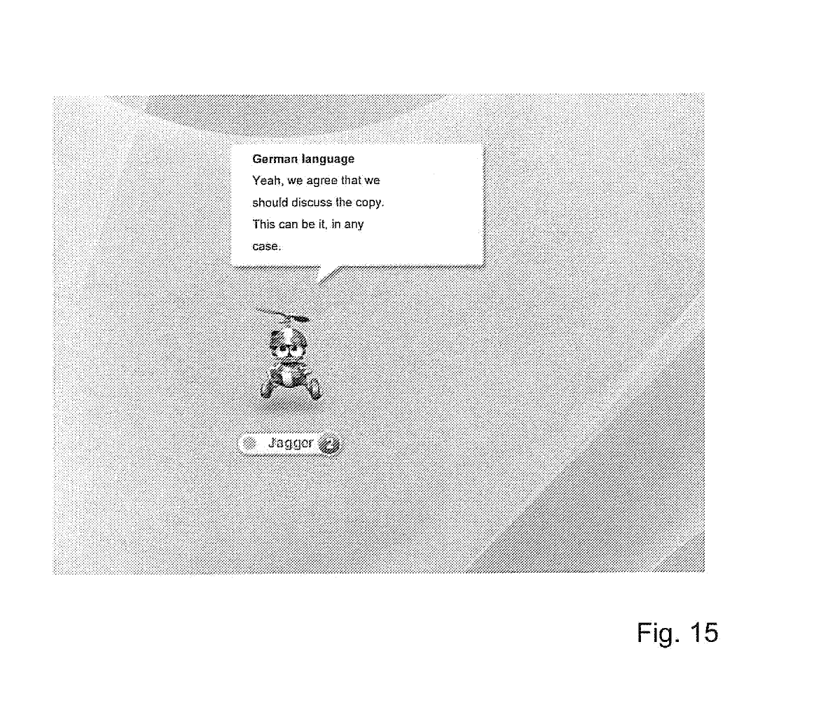

Furthermore, it is possible that when the communication partner sends a message, the message is displayed as a speech bubble (see FIG. 15) to the ComBOT™ symbol allocated to the communication partner, and furthermore the ComBOT™ symbol of the communication partner who has sent the text message executes a specific animation to attract the attention of the communication partner. A click on the speech bubble can then open a communication window which makes possible a further IM connection with the communication partner.

Additionally, there can be located in the communication window a selection element to call the animation selection menu which makes possible the selection of an animation for its own ComBOT™ symbol. Following selection, the selected ComBOT™ image is transmitted to the communication partner, with the result that the ComBOT™ symbol allocated to the current user executes the animation in order to communicate a specific emotion or mood non-verbally.

As FIGS. 16a-d illustrate in more detail, the selection menu 14 (ComBOT™ menu) can be progressively expanded around the ComBOT™ 13 and can be spatially securely allocated to it. In a preferred embodiment of the present invention, it is only when the user clicks on the ComBOT™ 13 or there is a mouseover does the ComBOT™ menu 14 appear, very small at first, then begin to expand almost “out of nothing” as shown in FIG. 16a. The menu 14 expands spirally or spiral-shaped to form a ring enclosing the ComBOT™ and the individual segments become increasingly more visible, as illustrated in FIGS. 16b and 16c. The spiral movement is realized by a corresponding graphic animation and shown here in FIG. 16b by a symbolic arrow. The menu 14 itself has a semi-transparent appearance at least during the development phase, with the result that the user can still easily recognize the ComBOT™. The spiral movement is concluded in the position in which the menu 14 has reached its predefinable final size and the segments are located in the predefinable normal positions, with the result that the menu 14 completely encloses the ComBOT™, as shown in FIG. 16d.

While the invention has been particularly shown and described with reference to preferred embodiments thereof, it will be understood by those skilled in the art that various changes in form and details may be made therein without departing from the spirit and scope of the invention.

What is claimed is:

1. A method for providing a selection menu allocated to a displayed symbol on a display unit having a display interface using an user-operated input device, the method comprising the steps of:
detecting a predefined action, performed using the user-operated input device, in a spatial relationship to the displayed symbol; and
displaying, upon the detecting of the predefined action, a selection menu enclosing the displayed symbol, the selection menu comprising a plurality of menu items each selectable using the user-input device so as to execute a function of a user program, the selection menu being functionally and graphically allocated to the displayed symbol.

2. The method as recited in claim 1, wherein the selection menu completely surrounds or confines the displayed symbol.

3. The method as recited in claim 1, wherein:
the input device is an operating element for controlling a pointer on the display unit, and
the predefined action comprises an operation of the operating element such that the pointer touches the displayed symbol or triggers a function allocated to the displayed symbol.

4. The method as recited in claim 3, wherein the operation comprises at least one of:
a left mouse click;
a right mouse click; and
a movement of the input device without an operation of a button of the input device;
a to-and-fro movement of the input device in a horizontal direction;
a to-and-fro movement the input device in a vertical direction; and
a circular movement of the input device.

5. The method as recited in claim 1, wherein:
the selection menu is arranged in a circular form.

6. The method as recited in claim 1, wherein:
the selection menu is arranged in a ring-shape, and
the displayed symbol remains visible inside the ring-shaped selection menu.

7. The method as recited in claim 6, wherein the plurality of menu items are displayed as segments of the ring-shaped selection menu.

8. The method as recited in claim 7, further comprising the steps of:
providing each of the segments with a selection element; and
selecting a corresponding selection element using the input device so as to select the function of the user program.

9. The method as recited in claim 8, further comprising the step of:
highlighting, when a mouse pointer is positioned on one of the selection elements, a relevant selection element by displaying the relevant selection element as at least one of enlarged, laterally displaced on the display interface, in a different color, and animated.

10. The method as recited in claim 9, further comprising the steps of:
displaying, when the mouse pointer is positioned on one of the selection elements, an information selection element relating to a display of a corresponding selection element; and
providing help information when the information selection element is activated.

11. The method as recited in claim 1, wherein the step of displaying the selection menu further comprises the step of:
spiralling the selection menu outwards around the displayed symbol by turning and enlarging until the selection menu has reached a definitive size or a predefinable maximum size.

12. The method as recited in claim 1, further comprising the step of:
removing the selection menu by activating a further function not provided by one of plurality of menu items so as to spiral the selection menu inwards around the displayed symbol by turning and shrinking until the selection menu has completely disappeared from the display interface or has reached a predefinable minimum size.

13. A device for providing a selection menu allocated to a displayed symbol, the device comprising:
a graphic display unit comprising a display interface;
an input device operable to perform a predefined action;
a control unit operable to detect the predefined action in a spatial relationship to the displayed symbol, and further operable to trigger a display, upon detection of the predefined action, of a selection menu enclosing the displayed symbol, the selection menu comprising a plurality of menu items each selectable using the input device, the selection menu being functionally and graphically allocated to the displayed symbol.

14. The device as recited in claim 13, wherein:
the input device is an operating element, and
the control unit is further operable to control a pointer on the display unit.

15. The device as recited in claim 14, wherein:
the operating element is a computer mouse,
the pointer is a mouse pointer,
the control unit is operable to detect at least one of the following actions as the predefined action:
operation of the operating element where the pointer touches the symbol or triggers a function allocated to the symbol;
a left mouse click on the computer mouse;
a right mouse click on the computer mouse;
a mouse movement with or without operating one of the buttons of the computer mouse;
a to-and-fro movement of the mouse in a horizontal direction;
a to-and-fro movement of the mouse in a vertical direction; and
a circular movement of the mouse.

16. The device as recited in claim 13, wherein:
the control unit is operable to drive the display unit in order to display the selection menu circular so as to have a ring-shape, and
the displayed symbol remains visible inside the ring-shaped selection menu.

17. The device as recited in claim 16, wherein the control unit is operable to display the display unit such that the plurality of menu items are displayed as segments of the ring-shaped selection menu.

18. The device as recited in claim 17, wherein:
the control unit is operable to display the display unit such that each of the segments is provided with a selection element, and
the corresponding selection element is selected with the help of the input device to select the function of the user program.

19. The device as recited in claim 18, wherein:
the control unit is operable to display the display unit such that when the mouse pointer is positioned on one of the selection elements, a relevant selection element is highlighted by being displayed as at least one of enlarged, laterally displaced on the display interface, in a different color, and animated.

20. The device as recited in claim 19, wherein:
the control unit is operable to display the display unit such that when the mouse pointer is positioned on one of the selection elements, an information selection element is displayed relating to the display of the corresponding selection element, and
help information is provided when the information selection element is activated.

21. The device as recited in claim 13, wherein:
the control unit is operable to display the display unit such that, to display the selection menu, the selection menu spirals out around the displayed symbol by turning and enlarging until the selection menu has reached a definitive size or a predefinable maximum size.

22. The device as recited in claim 13, wherein:
the control unit is operable to display the display unit such that the selection menu is removed by activating a further function, which is not provided by one of the plurality menu items, the selection menu spiralling inwards around the symbol by turning and shrinking until the selection menu has completely disappeared from the display interface or has reached a predefinable minimum size.
